(19) United States
(12) Patent Application Publication
(10) Pub. No.: US 2006/0136298 A1
(43) Pub. Date: Jun. 22, 2006

(54) Methods and apparatus for contextual advertisements in an online conversation thread

(75) Inventors: Stephen D. Klein, Spinnerstown, PA (US); Patrick F. Guiney, New York, NY (US); Timothy Kay, Los Altos, CA (US)

Correspondence Address: DALY, CROWLEY, MOFFORD & DURKEE, LLP, SUITE 301A, 354A TURNPIKE STREET, CANTON, MA, 02021-2714, US

(73) Assignee: Conversagent, Inc.

(21) Appl. No.: 11/304,237

(22) Filed: Dec. 14, 2005

Related U.S. Application Data
(60) Provisional application No. 60/636,753, filed on Dec. 16, 2004.

(51) Int. Cl. G06Q 30/00

(52) U.S. Cl. 705/14

(57) ABSTRACT

In one aspect, the invention relates to a method of providing at least one of an advertisement and a link to an advertisement to a user logged in to an instant messaging network. The method includes the steps of logging a message processor into the instant messaging network under a first screen-name by providing a message processor name and a message processor authentication, the user having the first screen-name as an authorized partner and being advised by the instant messaging network of the presence of the message processor. The method also includes the steps of receiving a communication addressed to the first screen-name from the user via the instant messaging network in an instant messaging protocol, and sending at least one of an advertisement and a link to an advertisement received from the advertisement server to the user.

### CROSS REFERENCE TO RELATED APPLICATIONS

The present application claims the benefit of U.S. Provisional Application No. 60/636,753, filed on Dec. 16, 2004, which is incorporated herein by reference.

### STATEMENT REGARDING FEDERALLY SPONSORED RESEARCH

Not Applicable.

### BACKGROUND

Internet users are well versed in accessing the Internet using widely available web browsing software to search for desired information. The web browser software permits users to access various automated search engines and, by entering appropriate queries, identify web pages which may contain the information of interest. While a wide variety of information is available in this manner, most web pages are directed to specific types of information. As a result, users who are seeking information in various diverse topics will often need to locate and access multiple, and perhaps unrelated, web pages. While users can find a great deal of in-depth information regarding particular topics, it can often be very difficult to obtain answers to short and specific questions due to the overwhelming number of web pages which will be identified in conventional indexing and search engine-based systems.

Various efforts have been made to aggregate diverse information onto one or a few web pages. However, these aggregated sites are often maintained by individual users as “personal web pages” and are thus of questionable reliability. Although some commercial web sites have been implemented for the purpose of aggregating information, these sites generally compete among each other for users and thus include many graphical features and expanded functionality to increase the site's attractiveness and increase revenue from multiple and various sponsored web links. However, this additional functionality also makes these sites more cumbersome and slow to access and use because of the additional data and processing overhead.

Another widely used Internet application is instant messaging (“IM”). IM services of one form or another are in use by an estimated 200 million people or more. Unlike Internet browsing software, which is used to access various web pages, IM is primarily used by a subscriber to “chat” with one or more other IM users. To access an IM service, a user registers with a service provider and, after connecting to the Internet (or other appropriate data network), enter their screen name and password to log in to the IM network. Popular IM applications include AOL's Instant Messenger and Microsoft's Network Messenger services. Once a user has logged in to the appropriate IM network, his presence on the system is made known to all authorized chat partners (commonly termed “buddies”). The user can then engage in typed conversations with other IM users connected to the system.

Because IM is a text-based service, instant messaging communication is generally not burdened by the need to transfer large graphic, sound, or program files. As a result, instant messaging is a relatively quick and easy to use system. However, while instant messaging is widely available, its value as a means to access and retrieve data from a remotely located automated system has not been fully appreciated.

### SUMMARY

The present invention provides methods and systems for providing services via an instant messaging service. In general, the system includes a message server that is connected to a data network through an instant messaging port. The server is logged in to the IM network and assigned a designated screen-name, such as “ACTIVEBUDDY”. When the message server receives an IM message from a user, the message is processed to determine the type of request made by the user and the appropriate actions necessary to service the request. In one embodiment, the request is an informational query. In response to such a request, the message server directs the query to an appropriate query response server, which server will interpret the request and return a suitable answer. The query response server(s) can be local to the message processing server or remotely accessed, e.g., via the Internet. The received answer is embedded in a message that is returned to the user, preferably over the IM system. Alternatively, the message server can interpret the request directly using various natural language processing techniques known to those skilled in the art. In one configuration, a table of query patterns is provided and the table is searched to identify the pattern most closely matching the received request. A designated local or remotely located resource is then accessed to determine an answer for the query, which answer is returned to the user.

It will be appreciated that, in order to generate an accurate answer to many types of queries, additional or secondary information may be required to fill in unstated assumptions in the query. To aid in providing this information, a user profile can be maintained by the system in which commonly needed information is stored. The types of information suitable for placement in the profile include static data such as the user's birth date, place of residence, fairly static information, such as stock portfolio data, and dynamic information, such as information gleaned from the prior most recent communications with the user. When the system determines that additional information is required, either by processing the request directly or in response to a message forwarded by a query response system indicating that more data is needed to process the request, the information is retrieved from the profile.

If the needed additional information is not already present in the user's profile and cannot be reasonably determined through other intermediate data searches, the user can be solicited to provide the additional information. Such solicitation can be through a query message sent to the user over the IM network or by means of a message instructing the user to access and update their profile via a designated web site. After the additional data is received from the user, the original query is reprocessed with the additional data and the result is returned to the user. The additional data can be stored in the user's profile for use in the future. In addition, information extracted from a prior request or provided in an answer can also be stored in the user profile for at least a predetermined period of time to permit the user to ask a series of questions or make a series of request related to a particular item without having to specify the same item in every request. For example, a user can issue a query asking the local time in New York City. In a following query, the user can simply ask “What is the weather today?” The object of the first request (New York) is used to process the second request. Processing and reusing data in this way makes the resulting text dialog appear more natural and simplifies use of the system.

In one aspect, the invention relates to a method for use in providing advertising to a user logged in to an instant messaging network. The method includes the steps of logging a message processor into the instant messaging network under a first screen-name by providing a message processor name and a message processor authentication, the user having the first screen-name as an authorized partner and being advised by the instant messaging network of the presence of the message processor. The method also includes the step of receiving a communication addressed to the first screen-name from the user via the instant messaging network in an instant messaging protocol and sending at least one of a keyword and a key phrase from the message processor to an advertisement server after receiving the communication addressed to the first screen-name. Also included in the method is the step of sending at least one of an advertisement and a link to an advertisement received from the advertisement server from the message processor to the user.

In one embodiment, the method includes the step of determining the at least one of the keyword and key phrase to send to the advertisement server. In another embodiment, the step of determining the at least one of the keyword and the key phrase to send to the advertisement server includes using stored user information. The step of determining the at least one of the keyword and the key phrase to send to the advertisement server, in another embodiment, includes evaluating a current topic of conversation. In yet another embodiment, the step of determining the at least one of the keyword and the key phrase to send to the advertisement server includes the message processor changing a topic of conversation and generating the at least one of the keyword and the key phrase based on a new topic of conversation. Alternatively, the step of determining the at least one of the keyword and the key phrase to send to the advertisement server may include evaluating an aggregate preference of all users having the first screen-name as an authorized partner. In other embodiments, the step of sending the at least one of the keyword and the key phrase to the advertisement server comprises sending at least one of keywords and key phrases that are programmed by the message processor's developers.

In another aspect, the invention relates to a method of providing at least one of an advertisement and a link to an advertisement to a user logged in to an instant messaging network. The method includes the steps of logging a message processor into the instant messaging network under a first screen-name by providing a message processor name and a message processor authentication, the user having the first screen-name as an authorized partner and being advised by the instant messaging network of the presence of the message processor. The method also includes receiving a communication addressed to the first screen-name from the user via the instant messaging network in an instant messaging protocol, parsing the communication to determine a topic of conversation, and sending at least one of a keyword and a key phrase from the message processor to an advertisement server after parsing the communication addressed to the first screen-name. Also included in the method is the step of sending at least one of an advertisement and a link to an advertisement received from the advertisement server from the message processor to the user.

### BRIEF DESCRIPTION OF THE DRAWINGS

The foregoing and other features of the present invention will be more readily apparent from the following detailed description and drawings of the illustrative embodiments of the invention in which:

FIG. 1 shows a high level block diagram of a first embodiment of a system implementing various aspects of the invention;

FIG. 2 is a block diagram of a second embodiment of a system implementing various aspects of the present invention;

FIG. 3 is a block diagram of a message routing system for use in the present invention;

FIGS. 4A-4B are flow charts of various aspects of the operation of a message processor for use in the systems of FIGS. 1 and 2;

FIG. 5 is a flow chart illustrating one technique of interpreting requests received from a user in accordance with one embodiment of the invention;

FIGS. 6A-6B are flow charts of various aspects of the operation of a message processor for use in the systems of FIGS. 1 and 2; and

FIG. 7 is a flow chart of a process for requesting and receiving advertisements from an advertising server in accordance with one embodiment of the invention.

### DETAILED DESCRIPTION

Before describing the invention in detail, some introductory information is provided. Instant messaging services were originally designed to facility person-to-person communication. Here, a user runs IM client software on their terminal device, such as a computer at work, a computer at home, a television set-top box, a cell phone, an IM appliance, or the like. The IM client software communicates over a network to an IM service. However, the user must first login to the IM service by providing both a unique identifier, called a “screen name,” and a secret password.

After validating the password, the IM service then provides certain information and services to the user. The information provided by the IM service includes (but is not limited to) a stored contact list, which is a list of screen names with whom the user commonly frequently communicates. The IM service also provides information about preference settings selected by the user. The preference settings may be used to control the behavior of client software, such as whether to play sounds when certain events occur.

The ability of the IM service to store information permits a user to log in from different terminal devices and access the same stored information. As a result, the user experience is consistent regardless of the point of access. The ability to login from different terminal devices while obtaining the same user experience is known as “roaming.”

The services provided by the IM service include “presence detection” for the screen names in the contact list: the service continuously updates the online status of each of the screen names mentioned in the contact list. By way of visual presentation of the contact list, the IM service may inform the user of the on-line status and the idle status of other contacts.

The IM service also provides messaging services. A user wishing to communicate with another user can click on the other user's screen name in the contact list, or by some other mechanism provided by the IM client software, to indicate the screen name of the other user. The IM service then establishes a communications channel between the two users and delivers short messages between the users in real-time.

It is possible to implement messaging services wherein the identities of the users are not authenticated, such as Internet electronic mail (e-mail) and Internet Relay Chat (IRC). User authentication was a key innovation that made IM different from other Internet messaging services. User authentication permits the IM service to keep track of individualized profile settings, thereby enabling roaming. During user authentication a unique key (e.g., the screen name) is assigned to each user such that their personal settings can be stored and retrieved in a secure and reliable manner.

User authentication enables presence detection. In this case, it is pointless to have a contact list unless the meaning of each screen name is constant and unique. Unique screen names permit consistent identification of users to the other users.

In addition, user authentication provides a user with the confidence of knowing that instant messages they receive originated from people that are identified as the senders of the instant messages. Unlike a message that is received via Internet e-mail or IRC, the identity of the sender of an instant message is very difficult to forge.

Originally, IM services were created to facilitate person-to-person communication. An interactive message processor is a software program that has its own screen name and password, and logs into an IM service as though it were a user. A user interacts with the interactive message processor in much the same way that the user would talk to another person. The user can add the screen name of the interactive message processor to their contact list. In addition, the user can initiate a conversation with the interactive message processor by either clicking on the appropriate screen name in the contact list or by some other mechanism as provided by the IM client software. The interactive message processor receives a message from a user, parses that message, formulates an answer, and sends that answer back to the user.

Further, an interactive message processor can provide a variety of services to a user via the IM service. For example, (i) games, such as word games and card games; (ii) information, such as stock quotes, weather reports, movie listings, and news; (iii) conversations; (iv) control, such as setting up a telephone conference call or activating the lawn sprinklers of a home; and (v) access, such as querying a database.

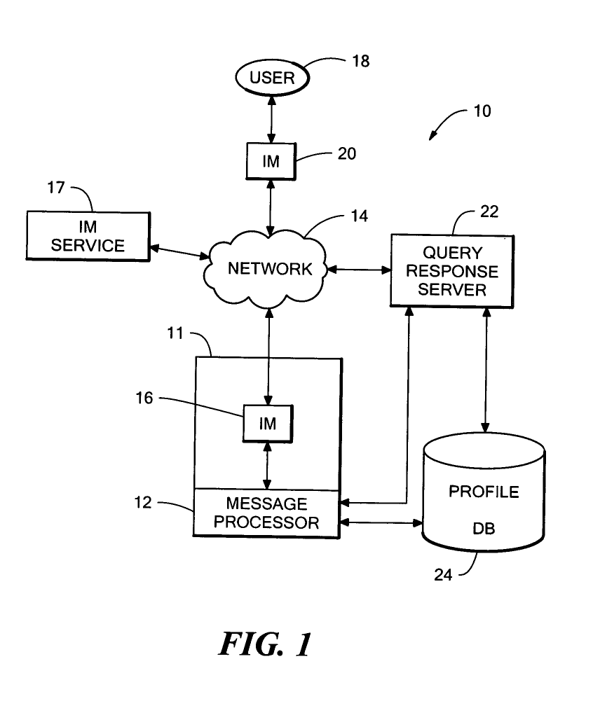

Turning to FIG. 1 there is shown a block diagram of a system 10 for interactively responding to requests or queries from a remotely located user. The system comprises a message router 11 which includes message processor 12. Processor 12 is coupled to a data network 14 and is logged in as a user of an instant messaging service provider 17 through an appropriate IM application or routine 16. A user 18 is connected to the network 14 and the IM service provider 17 through an instant messaging gateway 20. The instant messaging gateway 20 will typically be provided by an IM service provider to which the user has subscribed and allows access to the IM system after the user has logged in. The IM application 16 between message processor 12 and the network 14 is configured to enable access to the appropriate IM service provider(s). To provide instant messaging communication between message processor 12 and a plurality of users, which users may subscribe to different instant messaging providers, it may be necessary for message processor 12 to connect to a number of different IM service providers 17 through different gateways 16 or via a single IM protocol gateway 16 with several I/O processing routines to address situations where various messaging service providers do not share a data common protocol.

In an instant messaging environment, each user is provided with a unique screen name which is included as part of a message sent from the user to a designated destination. To direct a query or other request to messaging processor 12, a user, after logging in sends an instant message containing the request to the screen name assigned to the message processor 12, such as “ACTIVEBUDDY.” The message processor 12 is logged into the IM system and the IM system directs the message through the network to the processor 12.

When message processor 12 receives a request from the user, the screen name of the user is stored and, in this embodiment, the request, is forwarded to a local or remotely located query response server 22. In practice, query response server 22 will include a natural language interpreter or other smart system which is capable of responding to queries and other requests of an arbitrary nature related to topics within at least a specified range of issues by generating an appropriate answer. The answer generated by query response server 22 is returned to the message processor 12 where it is incorporated into an output message which is subsequently sent to the user through the IM network. Alternatively, or in addition, the output message can be forwarded to the user through any other designated means, including e-mail, fax, text messaging to wireless or hand-held devices, voice mail (via a text to speech output system), or any other type of messaging system specified by the user.

Various types of information received during the query response interaction can be stored for later use in a user profile database 24 which contain various user profiles associated which each user. The profiles can be keyed to a user screen name in combination with the name of the instant messaging provider, for example “john@aol”. The profile database 24 is preferably maintained on a separate server which is accessible to both message processor 12 and query response server 22, although other data storage configurations are feasible. By storing data provided by the user during a profile set up session and/or in response to data solicitation requests, a sophisticated query system can be provided which can make use of secondary or implied information to return a response which is more accurate or based on implicit data which need not be entered by the user in each query.

For example, a user may issue a query “What is the weather in Sunnyvale?” The query response server would process this query, determine the most likely “Sunnyvale” based on available information about the user, and access a suitable Internet weather resource to obtain the weather report for, e.g., Sunnyvale, Calif. In addition, the user's profile can be dynamically updated with the location Sunnyvale. As a result, a default location (if one was not already present) is available for use in subsequent location-dependent queries where the user does not specify a location. For example, the user may subsequently issue the query “Are there any outdoor concerts today?” In order to accurately answer this question, the query response server 22 must know a general geographic location. In this embodiment, the system could use the most recently mentioned geographic location, Sunnyvale, as the location for the search.

It will be appreciated that a large amount of default information can be provided in the user profile, such as a user age, or birth date, sex, place of residence, athletic teams of interest, stock portfolio information, etc. Because of the large quantity of information which can potentially be stored in the user profile, when a query from a user without a profile is detected, a “new user” procedure can be initiated in which the user is requested to provide various types of information to be stored in the user profile. In one embodiment, the user is directed to a specified profile web page in to which they can enter the various types of requested data. In another embodiment, a user's profile is dynamically generated using information which is extracted from communications with the user, such as user-initiated queries.

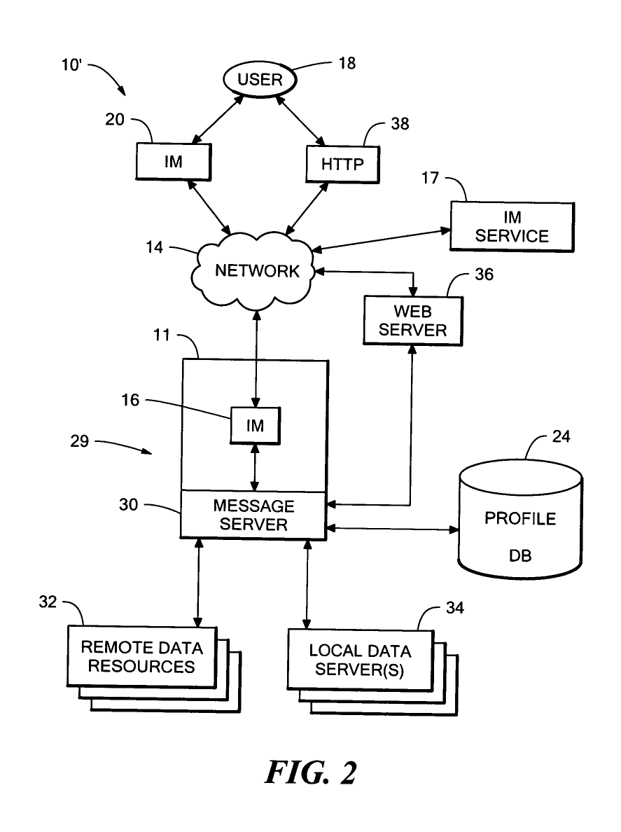

Turning to FIG. 2 there is shown a block diagram of a system 10′ according to a second embodiment of the invention. This embodiment is generally similar to the embodiment of FIG. 1 in that a message router 29 is provided which includes a message server 30 for responding to user's requests and which is connected to IM service 17 through a gateway 16. One primary difference is that the functionality of a separate query response server 22 of FIG. 1 is included within a local message server 30 such query processing is not outsourced as a matter of course. Message server 30 is connected to the profile database 24 and also to a series of remote and local data resources 32, 34. In addition, server 30 can be configured to access network 14 using multiple data protocols in addition to an IM protocol, and in particular, a hyper-text transfer protocol (“HTTP”) link via web server 36, which protocol is the dominant form of data messaging used by Internet web browsers. Also shown in FIG. 2 is a similar web browser interface 38 available to user 18.

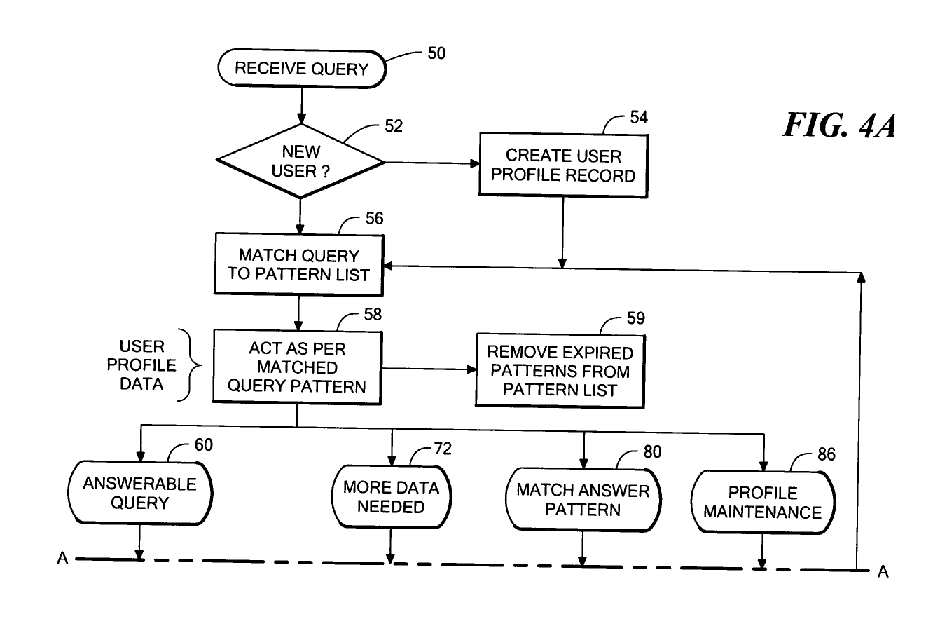

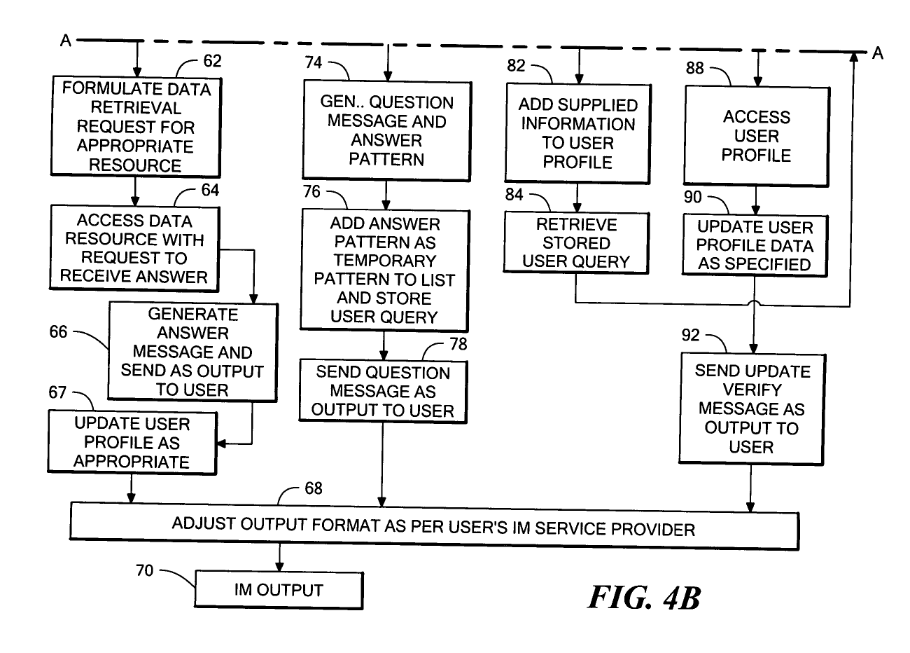

As discussed more fully below relative to the flow chart of FIGS. 4A-4B, message server 30 interprets a message containing a query or other request received from the user over the IM gateway 16 and accesses the appropriate data resource to fulfill the request. The type of data resource accessed depends on the information needed of the action requested. For example, various types of static information may be locally stored. Information of this type can include, for example, a zip code and area code look up databases, measurement conversions, and various geographic databases, such as a mapping or direction system. A local partially or fully cached version of a remote database can also be provided. Data suitable for storage in a local cached copy of a remote database includes information which changes relatively infrequently, and thus would only need to be updated on a periodic basis, not continuously. Examples of data of this type include geographic and political information and entertainment history. For data which is continuously updated, the server may be connected to remote data resources through, for example, the Internet, to allow retrieval of up-to-date information. Data which is best suited for retrieval from such remote resources includes package tracking, stock prices, airline flight status, and weather. As will be recognized, the remote data resources may have different access protocols. Thus, a number of different access application programs may be required in order to properly format an appropriate query to the resource and properly process the received reply. In one particular embodiment, the message server 30 processes a received request at least sufficiently to identify the appropriate data resource to query and formats the data access request accordingly. As will be recognized by those of skill in the art, various intermediate levels of request interpretation, query generation and processing, etc., can also be performed.

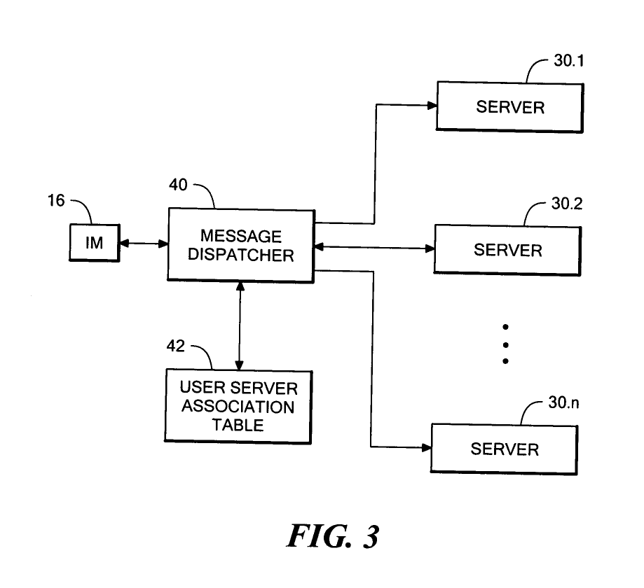

In operation, a large number of requests or queries can be pending for many users at the same time. Thus a larger number of separate “conversations” may be ongoing. In order to increase the system response time and decrease the load on any particular server, in one embodiment the incoming and outgoing instant messaging data stream is handled by a message router and forwarded to a plurality of servers 30.1 through 30.N as illustrated in FIG. 3. In one embodiment, the message dispatcher 40 maintains a table 42 of active users associated with each server (a user-server association table). When a message is received from a user not currently in the user-server table 42, that user is assigned to a server and placed in the user-server table, e.g., on a lowest load basis such that the server with the lowest number of active users is assigned the new users. Then, as data packets are received from the user through the instant messaging gateway 16, the data packets are processed by the message dispatcher 40 and routed to an appropriate server according to the user-server association table 42.

Advantageously, such a message dispatching system can be configured so that each server 30.x believes itself to be the only server in the system and is unaware of the intervening message router 40. In addition, the system can be configured so that the entire system or server 30.1 through 30.N appears to a user under the single screen name used by the system 10 (or 10′). This arrangement simplifies the addition of and removal of servers 30.x to the system without substantial reconfiguration being required. Various techniques for configuring a message router 40 will be known to those of skilled in the art. In one embodiment, the dispatcher 40 and user-server association table 42 are controlled with a suitable load balancing algorithm to evenly distribute the request load across the available server base in response to varying usage conditions.

FIGS. 4A-4B are flow charts showing the general operation of a message processor server 30, such as shown in FIG. 2. While this flow will be discussed with reference to the architecture shown in FIG. 2, many aspects of this technique are also applicable to controlling the message processor 12 and separate query response server 22 illustrated in FIG. 1. Turning to FIGS. 4A-4B, the server waits to receive a query, request, or other communication from a user (step 50). A screen name or other ID associated with a received query is determined and a check is made to see if a user profile has already been associated with the user (step 52). If no profile is found (i.e., the communication is from a new user), a user profile record is created and stored in the profile database 24 (step 54). The received query is then interpreted and acted upon. In a particular embodiment, the query is interpreted by comparing it to a list of predefined query patterns and identifying the pattern which most closely matches the received query. Once the query pattern is determined, the appropriate action is taken to answer the query or otherwise fulfill the request (step 58). As will be appreciated, certain queries may require secondary or additional information. This information may be present in the user profile. Accordingly, the user profile information in one embodiment is made available to, and can be referenced by, the system which is interpreting and/or acting on an interpreted query, or request.

FIGS. 4A-4B illustrate four basic types of requests which can be received and acted upon. These types are exemplary in nature and it will be appreciated that other types of requests in different classifications can also be handled by adjusting the present system and method as required.

A first type of query is what can be considered to be an “answerable” query. In other words, this type of query can be answered without additional input from the user (although access to data in the user profile or another secondary source may be required). Following receipt of an answerable query (step 60) a data retrieval request is formulated as required for the appropriate data resource (step 62). If the data resource is local, the data resource is directly accessed as appropriate using the formulated request. If the data resource is remotely located, the resource request is formatted as required for the given resource and forwarded through an appropriate communication link, such as the Internet (step 64). After the answer is received or extracted from the data resource, an answer message is generated and configured to be sent to the user as output. (Step 66). The user profile can also be updated, as appropriate, in accordance with any new or updated information garnered from the interaction.

Because various users may be connected to the system through IM providers which support incompatible display options, a presentation layer in one embodiment is provided for adjusting the format of output messages in accordance with knowledge of the data formatting requirements for the user's particular IM service provider. In one embodiment, the presentation layer consists of a script processing mechanism somewhat similar to script processing provided by the XML language. Each message processed by the message server is initially formatted to include all formatting options for all supported IM systems. For example, the initial output message can contain both bold text and embedded URLs even though, e.g., one IM system supports bold text but not embedded links, while a second IM system supports embedded links but not bold text. During the output processing, the presentation layer determines the target IM system and its supported capabilities and/or formatting requirements. The unsupported or excess formatting is removed and the remaining message is adjusted, as needed, to be in a format suitable for the target IM system.

The output message, properly formatted as required, is then forwarded to the user through the IM gateway 16 (step 70). Alternatively, or in addition, the output can be directed to an additional or different address or device specified by the user, either in the particular received query, in a prior query, or as a field in the user profile.

Certain queries received by the user will not be answerable without additional data. For example, a user may submit a query inquiring about “the weather” without specifying a geographic area. In the event that such a query is received, a determination is made regarding the type of data which is missing and (provided the information is not already in the user's profile) a question message soliciting this information from the user is generated (steps 72, 74).

In one embodiment, a separate subroutine is initiated during which the system assumes that the next communication from the user will be a response to the query message and the data in the response will be stored and used as appropriate (not shown). In another embodiment, however, the particular answer pattern associated with the generated questions is added as a temporary pattern to the query list and is associated with the particular user (step 76). The more-data-needed query can also be stored in the user profile for later use. In this manner, and as discussed further below, a response to the generated question can be detected without requiring additional and separate data processing routines which limit the responsive actions which can be taken by the user. Finally, the question message is configured as output to the user (step 78) and forwarded through the output presentation layer and the IM gateway (steps 68, 70).

In one embodiment, answer patterns are added as temporary query patterns and expire within a designated period of time. Thus, a process can be initiated on a periodic basis to remove expired patterns from the pattern list (step 59). In addition, temporary patterns associated with a given user may be removed when a subsequent communication from that user is received, regardless of whether the communication matches the query or not. This allows a user to abandon a query which requires more data and simply issue a new query (which will not match the temporary pattern).

By storing an answer pattern as a temporary pattern at the beginning of the query pattern list, the system can easily and quickly identify user communications which are responses to a data needed question. When a response matches an answer pattern (step 80) the information returned by the user is extracted and added to the appropriate fields in the user profile (step 82). The original user query which spawned the “more data needed question” is then retrieved from the user profile and reissued as if were just received from the user. During this second attempt, the required information can be retrieved from the user profile and the user's query executed without interruption (steps 84, 56). In the event that further secondary or additional information is required, the data solicitation procedure can repeat until the query is answerable or a failure condition is recognized.

In addition to issuing queries to request information, a user can issue requests to perform maintenance of their profile. For example, a user can request that the system add a designated number of stock shares to their profile for tracking purposes. Profile maintenance commands can be identified through general natural language processing, such as query pattern matching, or can be identified through particular introductory key words, such as “PROFILE:”, which indicates that the request is a profile update and not a general informational query. When a profile maintenance request is detected (step 86) the appropriate user profile is accessed (step 88). The user profile is then updated in accordance with the user specification (step 90). Finally a message indicating the success or failure of the update can be generated and forwarded to the user (steps 92, 68, 70).

Various other types of user queries may also be received in addition to those specified in FIGS. 4A-4B. Other types of requests which can be processed in accordance with the present invention include, for example, a request to control a device connected to the Internet, a request to schedule a reminder, a request to send a message to a third party by a wireless messaging service, and a request to purchase particular goods or commodities. The specific implementation details are request-type dependent. The particular techniques and interface protocols required to process these types of requests will vary according to the implementation and platform technology. Various response techniques will be known to those of skill in the art and will therefore not be discussed further herein.

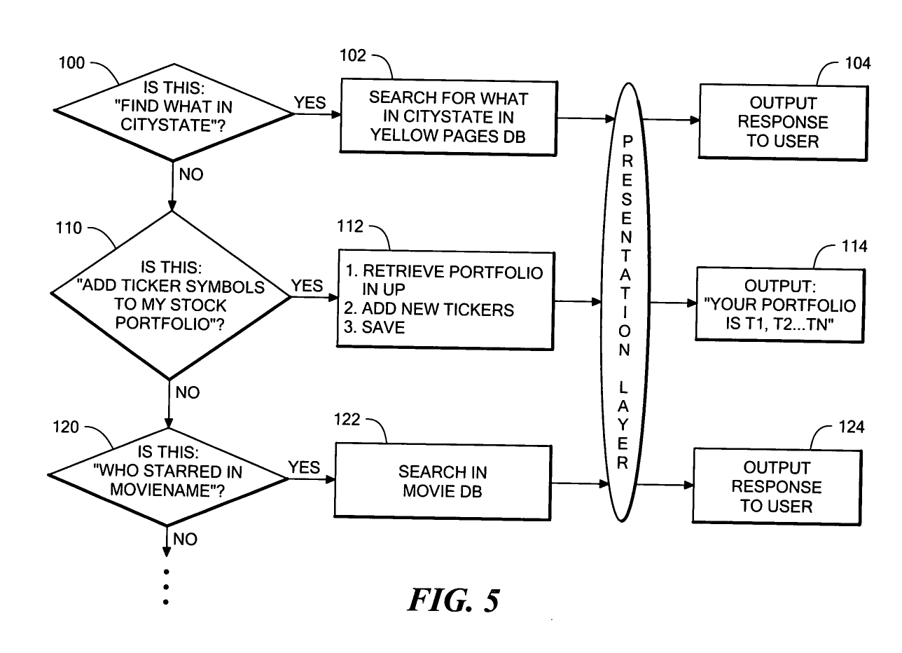

FIG. 5 is an excerpt from a sample query pattern list which is written in a flow-chart style and which illustrates the association between particular queries and designated actions. For example, a first query pattern 100 can be of the form “Find <WHAT> in <CITYSTATE>”. If this query pattern is detected, the designated response (block 102) is to search for the identified “what” in the identified “citystate” using, for example, a yellow pages database. The results of the search are then processed by the presentation layer and output to the user.

A second pattern 110 is of the form “Add <TICKERSYMBOL> to my portfolio”. When this query pattern is detected, the request is interpreted as a profile maintenance request. As indicated at block 112, the designated response is to retrieve the ticker portfolio from the user's profile, add the specified stock ticker symbols to the portfolio, and save the result. The response 114 to the user is here designated as a listing of the contents of the updated portfolio.

Finally, a query can be of a generic informational request, such as the third pattern 120 “Who starred in <MOVIENAME>”. The associated action 122 is to search a designated movie database to retrieve the stars of the specified movie. This information is then output as a response 124 to the user. As will be appreciated, once a sufficiently complete query pattern list has been generated, a wide variety of common user requests can easily be processed without manual input. A query pattern list of this type can be implemented in a variety of fashions. In one embodiment, the query patterns are implemented as PERL regular expressions statements which are processed according to conventional techniques. In an alternative embodiment, the language processing routines are written in C (or a variant of C) using language processing algorithms known to those of skill in the art. As discussed previously, instant messaging services assign unique, authenticated screen names, for various compelling reasons. In accordance with the invention, this unique, authenticated screen name is used to provide interactive agents with the ability to customize their responses for each user.

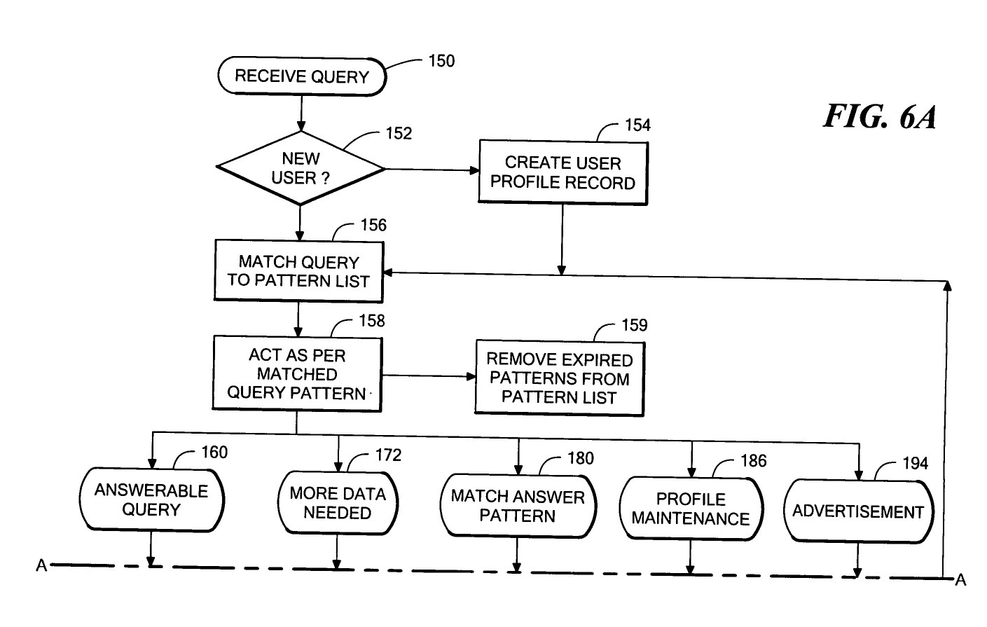

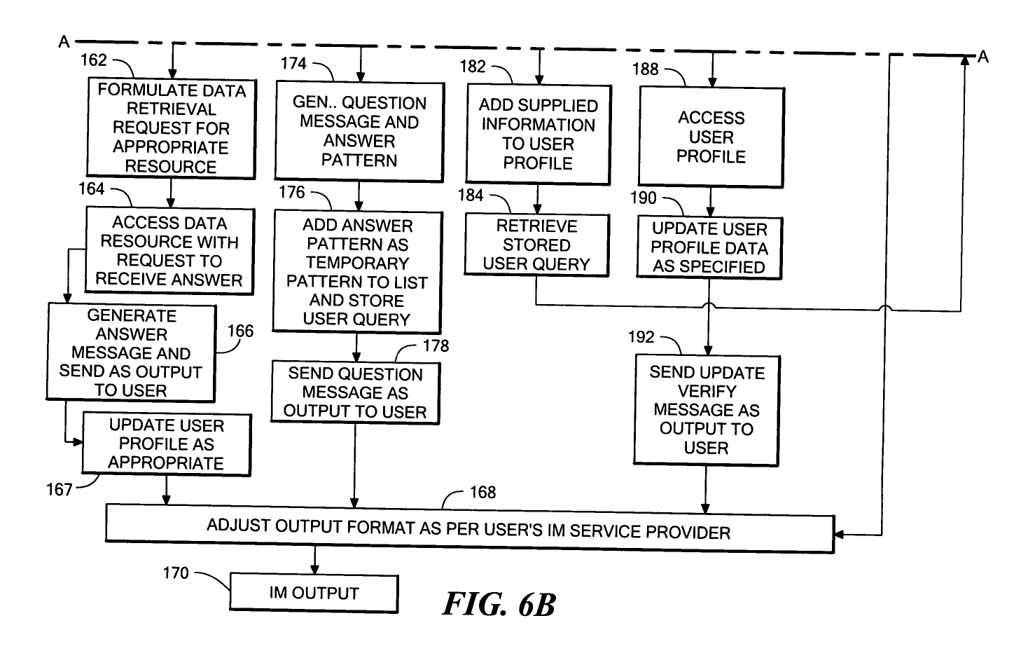

FIGS. 6A-6B show another embodiment of the general operation of a message processor 30, such as shown in FIG. 2. The server waits to receive a query, request, or other communication from a user (step 150). The communication may be in the form of a text string consisting of natural language words, phrases or sentences, and the text string is delivered to the automated message processor. A screen name or other ID associated with a received communication is determined and a check is made to see if a user profile has already been associated with the user (step 152). If no profile is found (i.e., the communication is from a new user), a user profile record is created and stored in the profile database 24 (step 154).

The message processor then programmatically processes the text string provided by the user to determine the subject matter of the text. After determining the subject matter, the message processor processes the subject matter to determine an appropriate response as discussed earlier with reference to FIGS. 4A-4B.

In some cases, in addition to generating a response to a user's communication, the message processor decides whether to generate and send an advertisement to the user along with the response to the query (step 194). The message processor chooses whether or not to display an advertisement based on any number of conditions, such as the areas of knowledge related to each query being processed by the message processor. In another embodiment, the message processor chooses whether or not to send an advertisement based on a random event, for example, the message processor sends an advertisement if a certain number between one and ten selected by the processor matches a second randomly generated number that is between one and ten. In other embodiments, the message processor chooses whether to send an advertisement based on the type of query sent by the user, the time of day, etc.

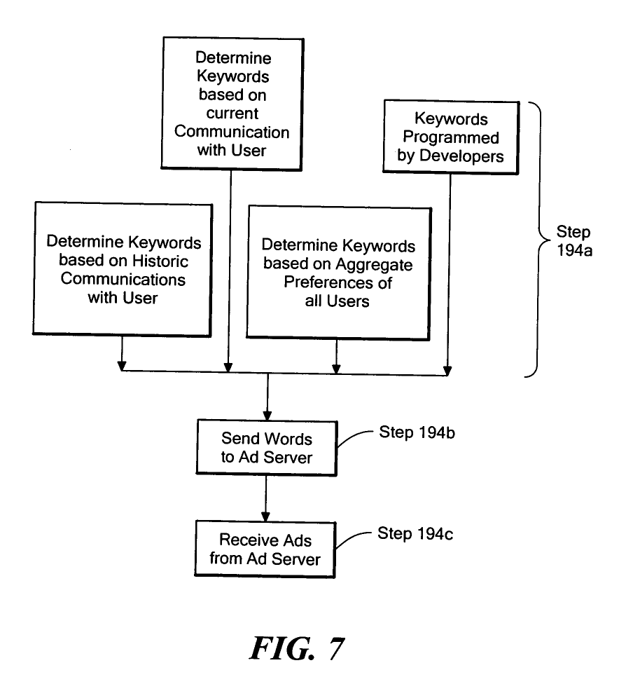

With reference to FIG. 7, if the message processor chooses to display an advertisement, the message processor then chooses a keyword or key phrases to send as input to an advertisement server as described below (step 194a). The message processor then sends the keywords or key phrases to the advertisement server (step 194b), receives in return an advertisement from the advertisement server (step 194c), and sends the advertisement to the user along with the response from the message processor (steps 168, 170).

In other embodiments, the message processor retrieves information about the user at an arbitrary point during the conversation between the user and the message processor, and uses that information to determine key words or key phrases to send to the advertisement server. In another embodiment, the message processor retrieves information about the user and retrieves an advertisement based on that information at a specific point in the user-message processor conversation, such as when the user queries a particular area of the message processor's functionality.

With reference to FIG. 7, step 194 is shown in greater detail. If the message processor elects to send an advertisement to the user, the message processor first determines key words or key phrases to send to an advertisement server system (step 194a). The key words or key phrases are then sent to an advertisement server system, like Google Adwords or Overture, or any other advertisement system desired (step 194b) the keyword or search indicates. The message processor then receives advertising materials, in one embodiment in the form of text and appropriate internet links (step 194c), to present to the user. In another embodiment, the advertisement may be a message in its complete form, with no associated link to another internet location.

The keywords or phrases to be sent to the advertisement server in step 194a may be determined in several ways. For instance, in one embodiment, the subject matter of previous conversations between a user and a message processor that are recorded, for instance, in profile database 24 are used to generate keywords or key phrases. More specifically, user information such as user preferences, location, and birth date may be used as input information to an advertisement server program.

As an example, a company can build an interactive message processor that appears on an IM service as a screen name. For example, Macy's might create an interactive message processor named “Macy's” on the AOL Instant Messaging (AIM) service. The interactive message processor can have access to records that detail, for instance, previous products sold to users. Once a user is logged on to AIM, the user can initiate a conversation with Macy's. In response to a communication received from the specific user, Macy's may send a keyword to an advertisement server program based on the stored purchase information relating to the specific user. Macy's may then receive an advertisement from the advertisement server relating to current products the user may be interested in that are available at Macy stores.

In another embodiment, an advertisement is generated and supplied to the user based on keywords or key phrases determined from the current topic of conversation as identified and stored by the message processor. For instance, if the user asks the message processor for information about a particular sport, such as football, the message processor may store “football” as the current topic of conversation until a different topic is introduced by the user. In this embodiment, an advertisement may be retrieved and sent to the user based on the keyword “football.” For example, advertisements can be presented for football merchandise, future football games, football game trips, etc. In addition, advertisements can be contextualized based upon a particular football team, which may be determined based upon the geographic location or home address information. Sponsors may selected based upon the contextual information.

In an alternative embodiment, the message processor may introduce a new topic of conversation based on the areas of functionality and data served by the message processor, for example movies. In this case the message processor may append a question such as “Would you like to see what movies are playing in your area?” to the appropriate answer to the user's query. If the user agrees, then the current topic of conversation becomes “movies” and the message processor may subsequently generate and send to the user an advertisement based on the keyword “movies.” In one embodiment, advertisements for future movies, movies of a particular genre, movie-related merchandise, etc.

In another embodiment, an advertisement is generated and supplied to the user based on keywords determined from the aggregate preferences and/or interests of all users using the message processor. For instance, in one embodiment, if a certain percentage of users or a certain number of users indicate that they like a certain type of product, then an advertisement may be sent to the user depicting that type of product and where it may be purchased. The advertisement is generated and sent to the user even though the user may never have mentioned anything about the product in the current conversation, or any historical conversation with the message processor.

In a further embodiment, random advertisements can be sent to the user during a user's conversation with the message processor. These random advertisements do not utilize individual user queries, stored user information, or aggregate user behavior to determine which keywords or key phrases to send to the advertisement server. Instead, these advertisements are based on keywords or key phrases that are programmed by the message processor's developer(s).

In one embodiment, the message processor may favor one type of advertisement (for example, an advertisement tailored to a specific user) over others (for example, advertisements that are random). Alternatively, in another embodiment, the message processor may disregard one type of advertisement entirely. When the message processor has chosen to send an advertisement and chosen which type of advertisement to send, the appropriate keyword or keyphrase is sent to an ad server system such as Google Adwords (step 194b). If no advertisement is found and returned by the advertisement server system for that keyword or key phrase, the message processor may try to retrieve another advertisement based on a different keyword or key phrase. When an advertisement is retrieved, the message processor may display the advertisement embedded in conversational output, such as “By the way, my sponsor has something for you . . . .” Alternatively, in another embodiment, the message processor may display the advertisement in such a way that it is not incorporated in conversational output, but rather displayed as is in a separate line of text and perhaps formatted in such a way that might make it visually distinct from the message processor's conversational output.

The following is an example of an advertisement that can be provided to a user communicating with a message processor in an instant messaging format in accordance with one embodiment of the invention.

### EXAMPLE 1

User001: I like skateboarding
Message processor: You like skateboarding? That's cool, I'll remember that!
User001: what time is it?
Message processor: The time right now is 6:17 pm.
Hey, I thought you might be interested in this: Cheap Skateboards. Only the very best! [embedded link to advertiser's site—provided by ad server—embedded in advertisement message]

In this example, the user submitted the text string “I like skateboarding.” The message processor parsed the communication, recognizing the meaning of “I like” and recognizing “skateboarding” as the object of “I like.” The term “skateboarding” was added to a database of facts associated with User001 and flagged as a thing that User001 likes. Subsequently, when User001 made another query, the message processor responded to the query and chose to add an advertising message based on things this user likes. The message processor queried the database of User001's likes and randomly chose the keyword “skateboarding.” The message processor then sent the keyword “skateboarding” to the ad server's internet address via an HTTP post request. The ad server then returned the advertisement in XML form (however, in other embodiments, different formats may be used). The message processor then parsed the XML and displayed the advertisement in the desired format, incorporated into the text of the message processor's natural conversation.

Various different programmable computer hardware platforms can be used to implement the several aspects of the present invention. In one embodiment, the various components, such as message routers, dispatcher, query response servers, etc., are implemented on one or more computer systems which are substantially identical at the hardware and operating system level. This simplifies interactivity between the various systems and makes it simpler to port functionality from one computer to another to distribute the workload in accordance with, e.g., the number of computer systems available. The computers should be connectable to each other, for example, by means of 100Base-T Ethernet interfaces and corresponding 100Base-T Ethernet switches. At least one of the computers is connected to the data network. In one embodiment of an Internet implementation, the connection is through a firewall and via a 100Base-T connection provided by a data center. In another embodiment, each computer contains an a Intel L440GX+ motherboard, two Pentium III processors, 512 MB RAM, two Seagate 9 GB disk drives, and operates using the Unix compatible Linux operating system. As will be appreciated, the specific hardware utilized can be varied in accordance with need, required capacity, and the preferred programming and operating environment, as well as in response to other factors.

Other embodiments incorporating the concepts disclosed herein may be used without departing from the spirit and scope of the invention. The described embodiments are to be considered in all respects as only illustrative and not restrictive.

What is claimed is:

1. A method for use in providing advertising to a user logged in to an instant: messaging network, comprising the steps of:
a) logging a message processor into the instant messaging network under a first screen-name by providing a message processor name and a message processor authentication, the user having the first screen-name as an authorized partner and being advised by the instant messaging network of the presence of the message processor;
b) receiving a communication addressed to the first screen-name from the user via the instant messaging network in an instant messaging protocol;
c) sending at least one of a keyword and a key phrase from the message processor to an advertisement server after receiving the communication addressed to the first screen-name; and
d) sending at least one of an advertisement and a link to an advertisement received from the advertisement server from the message processor to the user.

2. The method of claim 1 further comprising the step of determining the at least one of the keyword and key phrase to send to the advertisement server.

3. The method of claim 2, wherein the step of determining the at least one of the keyword and the key phrase to send to the advertisement server comprises using stored user information.

4. The method of claim 2, wherein the step of determining the at least one of the keyword and the key phrase to send to the advertisement server comprises evaluating a current topic of conversation.

5. The method of claim 2, wherein the step of determining the at least one of the keyword and the key phrase to send to the advertisement server comprises the message processor changing a topic of conversation and generating the at least one of the keyword and the key phrase based on a new topic of conversation.

6. The method of claim 2, wherein the step of determining the at least one of the keyword and the key phrase to send to the advertisement server comprises evaluating an aggregate preference of all users having the first screen-name as an authorized partner.

7. The method of claim 1, wherein the step of sending the at least one of the keyword and the key phrase to the advertisement server comprises sending at least one of keywords and key phrases that are programmed by the message processor's developers.

8. A method of providing at least one of an advertisement and a link to an advertisement to a user logged in to an instant messaging network, comprising the steps of:
a) logging a message processor into the instant messaging network under a first screen-name by providing a message processor name and a message processor authentication, the user having the first screen-name as an authorized partner and being advised by the instant messaging network of the presence of the message processor;
b) receiving a communication addressed to the first screen-name from the user via the instant messaging network in an instant messaging protocol;
parsing the communication to determine a topic of conversation;
sending at least one of a keyword and a key phrase from the message processor to an advertisement server after parsing the communication addressed to the first screen-name; and
e) sending at least one of an advertisement and a link to an advertisement received from the advertisement server from the message processor to the user.

9. A method, comprising:
receiving, by a message processor, an instant message from a user;
determining whether to send an advertisement to the user;
sending an advertisement from an advertisement server to the user, the advertisement having content related to the instant message sent by the user.

10. The method according to claim 9, wherein determining whether to send the advertisement includes determining keywords from previous communications with the user.

11. The method according to claim 10, wherein the previous communications includes information stored in a profile for the user.

12. The method according to claim 9, wherein determining whether to send the advertisement includes determining keywords in the instant message from the user.

13. The method according to claim 9, wherein determining whether to send the advertisement includes determining keywords based upon aggregate preferences for a group of users.

14. The method according to claim 9, wherein determining whether to send the advertisement includes keywords identified in the advertisement server.

15. The method according to claim 9, wherein the advertisement comprises a link to a webpage.

16. The method according to claim 9, wherein the advertisement includes a query containing an offer for additional information.

17. A system, comprising:
a message processor for coupling to a network, the message processor to receive instant messages from a user for selectively sending advertisements to the user based upon predetermined criteria, the message processor to receive messages from an ad server for transmission to the user.

18. The system according to claim 17, wherein the predetermined criteria includes previous communications with the user.

19. The system according to claim 18, wherein the previous communications include information stored in a profile for the user.

20. The system according to claim 17, wherein the predetermined criteria includes keywords in a first one of the instant messages.

21. The system according to claim 17, wherein the predetermined criteria includes aggregate preferences for a group of users.

22. The system according to claim 17, wherein the predetermined criteria includes random keywords.
